(19) United States
(12) Patent Application Publication
(10) Pub. No.: US 2001/0021050 A1
(43) Pub. Date: Sep. 13, 2001

(54) Asynchronous transfer mode (ATM) optical signal matching apparatus

(75) Inventor: Hyun Soo Paik, Suwon (KR)

Correspondence Address: BAKER & BOTTS, 30 ROCKEFELLER PLAZA, NEW YORK, NY, 10112

(73) Assignee: Hyundai Electronics Inc. Co., Ltd.

(21) Appl. No.: 09/770,351

(22) Filed: Jan. 26, 2001

(30) Foreign Application Priority Data
Mar. 13, 2000 (KR) 2000-12440

(51) Int. Cl. H04J 14/08

(52) U.S. Cl. 359/139; 359/135

(57) ABSTRACT

There is provided an ATM optical signal matching apparatus which includes a plurality of photoelectric conversion parts for photoelectric-converting input data, a plurality of user-network matching parts for processing signals transmitted/received through the photoelectric conversion parts, a bus switch for exchanging signals with the plurality of user-network matching parts, a loop back processor for returning a signal received through the bus switch to an original transmitter sending the signal according to a predetermine control signal, and a controller for providing a control signal to the user-network matching parts and the loop back processor according to a program stored therein. The invention supports multi-line optical signal matching function to improve space utility, increase economic effect and provide high-rate data (especially, multimedia data) service at 155 Mbps or more. Furthermore, the ATM optical signal matching apparatus of the invention includes the loop back processors connected to maintenance device to accurately find out points having problems rapidly.

### BACKGROUND OF THE INVENTION

1. Field of the Invention

The present invention relates to an optical signal matching apparatus and, more particularly, to an asynchronous transfer mode (ATM) optical signal matching apparatus which is able to provide a transfer rate of OC-3 level among ATM switch matching cards necessarily included in a mobile communication system (IMT-2000 system) for realizing multimedia service of at least 64 Kbps.

2. Description of the Related Art

In general, an ATM switch, which is also called a self-routing switch, automatically selects, that is, routes a path from an input port to an output port in a hardware. Specifically, the ATM switch sequentially decodes bits of routing information (or address) in a cell header to repeatedly choose between “0” and “1”, thereby automatically selecting a path. This ATM switch which is an apparatus used in a mobile communication system (especially, IMT-2000 system) includes an optical signal matching apparatus which will be explained below.

The optical signal matching apparatus is a kind of signal matching apparatus for data communication service. This optical signal matching apparatus has higher transfer rate and lower error rate than conventional E1 matching apparatus and T1 matching apparatus so that it is in the spotlight as a new technique replacing the conventional signal matching apparatuses. The optical signal matching apparatus converts data in the form of electric signal into an optical signal to transmit it, or converts data received in an optical signal form into an electric signal.

Though the conventional optical signal matching apparatus can perform data service with a predetermined capacity because it supports the transfer rate of less than 64 Kbps, however, it cannot process large-capacity data service above the capacity. That is, the conventional optical signal matching apparatus is difficult to provide data service of above 64 Kbps or multimedia service while the upcoming IMT-2000 system requires the multimedia service. Accordingly, there is needed an optical signal matching apparatus capable of providing the multimedia service that will be supplied by the IMT-2000 system as well as being suitable for UTOPIA level 2.

### SUMMARY OF THE INVENTION

It is, therefore, an object of the present invention to provide an ATM optical signal matching apparatus capable of supporting UTOPIA level 2 and 155 Mbps physical layer and supporting OC-3 of 8-port for one card.

To accomplish the object of the present invention, there is provided an ATM optical signal matching apparatus which includes a plurality of photoelectric conversion parts for photoelectric-converting input data, a plurality of user-network matching parts for processing signals transmitted/received through the photoelectric conversion parts, a bus switch for exchanging signals with the plurality of user-network matching parts, a loop back processor for returning a signal received through the bus switch to an original transmitter sending the signal according to a predetermine control signal, and a controller for providing a control signal to the user-network matching parts and the loop back processor according to a program stored therein.

### BRIEF DESCRIPTION OF THE DRAWINGS

FIG. 1 is a block diagram of an ATM optical signal matching apparatus according to the present invention;

FIG. 2 is a block diagram showing an embodiment of an application of the ATM optical signal matching apparatus of the invention to an actual system.

### DETAILED DESCRIPTION OF THE PREFERRED EMBODIMENT

Reference will now be made in detail to the preferred embodiments of the present invention, examples of which are illustrated in the accompanying drawings.

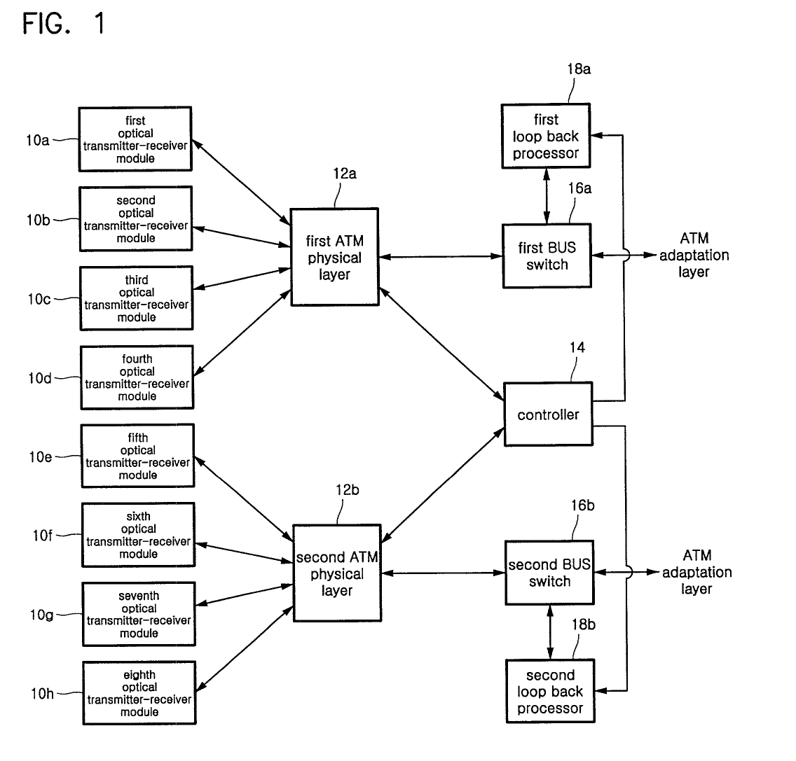

FIG. 1 is a block diagram of an ATM optical signal matching apparatus according to the present invention. Referring to FIG. 1, the apparatus includes first to eighth photoelectric conversion parts (optical transmitter-receiver modules) 10a-10h for photoelectric-converting received data, and a first user-network matching part (first ATM physical layer) 12a connected to the first to fourth optical transmitter-receiver modules 10a-10d for exchange and connection of data transmitted/received.

The ATM optical signal matching apparatus also includes a second user-network matching part (second ATM physical layer) 12b connected to the fifth to eighth optical transmitter-receiver modules 10e-10h for exchange and connection of transmission/reception data, and a controller 14 connected to the first and second ATM physical layers 12a and 12b to generate a control signal according to a program stored therein.

In addition, the apparatus has first and second bus switches 16a and 16b respectively connected to the first and second ATM physical layers 12a and 12b to perform a switching function for connection to an external apparatus, and first and second loop-back processors 18a and 18b respectively coupled to the first and second bus switches 16a and 16b to execute a loop back function.

The operation of the ATM optical signal matching apparatus having the aforementioned configuration is now explained. Each of the first to eighth optical transmitter-receiver modules 10a-10h has the transfer rate of 155.520 Mbps and each of the first and second ATM physical layers 12a and 12b accommodates four optical transmitter-receiver modules to support the transfer rate of a total of 622 Mbps. For example, the first ATM physical layer is connected to the first to fourth optical transmitter-receiver modules while the second ATM physical layer is connected to the fifth to eighth optical transmitter-receiver modules.

The controller 14 includes a firmware storing the program for generating a predetermined control signal, a memory for temporarily storing predetermined data, and a microprocessor for performing a predetermined operation function. The first and second loop back processors 18a and 18b receive a control signal for loop back operation from the controller 14 and carry out the loop back function that receives a test signal for testing a signal path from the outside and returns it to an original transmitter sending the test signal. For reference, an apparatus for transmitting the test signal for executing the loop back operation mainly takes charge of maintenance and detects errors on transmission lines through the state of the returned signal.

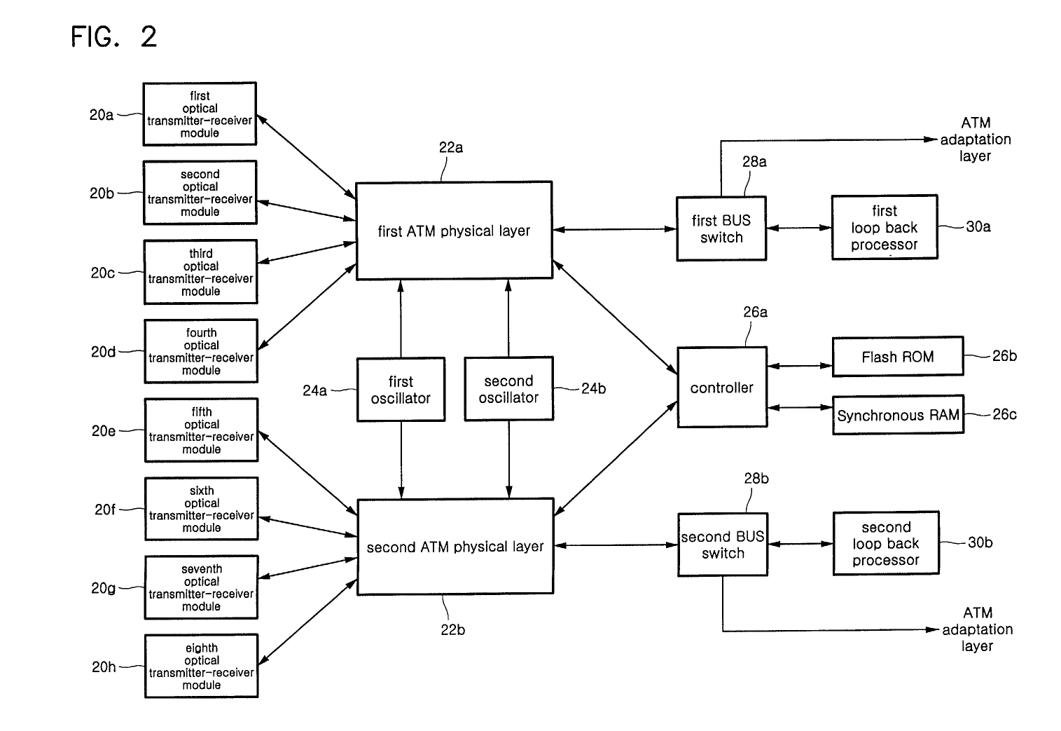

There is described below an embodiment of an application of the ATM optical signal matching apparatus of the invention to an actual system. FIG. 2 is a block diagram showing an embodiment of an application of the ATM optical signal matching apparatus of the invention to an actual system.

Referring to FIG. 2, the system includes a first to eighth optical transmitter-receiver modules 20a-20h for photoelectric-converting received data for transmission/reception of it, and first and second ATM physical layers 22a and 22b each of which is connected to four of the optical transmitter-receiver modules for exchange and connection of the received data. The system further includes a first oscillator 24a connected to the first and second ATM physical layers 22a and 22b to provide the reference clock of 19.4 MHz which is used for synchronizing data transmitted/received at 155.520 Mbps, and a second oscillator 24b connected to the first and second ATM physical layers 22a and 22b to provide the clock of 50 MHz for matching data transmitted/received at 155.520 Mbps to the UTOPIA level 2.

In addition, the system also has a controller 26a connected to the first and second physical layers 22a and 22b to generate a predetermined control signal, a flash ROM 26b connected to the controller 26a, and a synchronous RAM 26c connected to the controller 26a. The flash ROM is a nonvolatile memory and the synchronous RAM is a volatile memory. Here, the controller 26a may be a programmable microprocessor and it is MC68302 of Motorola in this embodiment.

The first and second ATM physical layers 22a and 22b are respectively connected to first and second bus switches 28a and 28b coupled to external apparatuses for switching transmission/reception data. These bus switches are respectively connected to first and second loop back processors 30a and 30b for carrying out the loop back function.

The operation of the system to which the ATM optical signal matching apparatus is applied is explained below.

First of all, data transmitted or received at the rate of 155.520 Mbps is photoelectric-converted through the first to eighth optical transmitter-receiver modules 20a-20h to be sent to the first and second ATM physical layers 22a and 22b. Specifically, data photoelectric-converted by the first to fourth optical transmitter-receiver modules 20a-20d is delivered to the first ATM physical layer 22a and data photoelectric-converted by the fifth to eighth optical transmitter-receiver modules 20e-20h is transmitted to the second ATM physical layer 22b. Here, these data items are synchronized with 19.44 MHz clock generated by the oscillator 24a according to the control signal sent from the controller 26a and matched to UTOPIA level 2 according to 50 MHz clock generated by the second oscillator 24b.

The controller 26a loads the program stored in the flash ROM 26b on the synchronous RAM 26c when system power is turned on and then accesses the loaded program to execute it. Upon execution of the program, the first and second ATM physical layers 22a and 22b process the data transmitted/received through the first to eighth optical transmitter-receiver modules 20a-20h at 155.520 Mbps. In case that there is generated an error on each optical transmitter-receiver module and each ATM physical layer, the controller 26a initializes interrupt to control it. Further, the controller 26a performs initialization to allow the first and second ATM physical layers 22a and 22b to communicate at UTOPIA level 2.

Each of the optical transmitter-receiver modules receives data in the form of optical signal and each of the ATM physical layers converts the optical-signal-form data into an electric signal to transmit it in the form of digital signal. The ATM physical layers 22a and 22b send the data received from the optical transmitter-receiver modules to the bus switches 28a and 28b at the UTOPIA level 2, respectively. Here, the bus switches 28a and 28b transmit lines requiring loop back among 155.520 Mbps lines to the loop back processors 30a and 30b to loop-back them but transmit lines that do not need loop back to external ATM adaptation layer matching parts.

The matching output of the UTOPIA level 2 of the first and second ATM physical layers has the rate of a total of 622 Mbps. The data stream of 622 Mbps received from the external ATM adaptation layers through the bus switches is converted into two sets of four 155.520 Mbps bit streams, being transmitted to the first to eighth optical transmitter-receiver modules. Here, each of the first and second loop back processors can selectively loop-back the four ATM signals and return the signals received from the first to eighth optical transmitter-receiver modules instead of transmitting it to the ATM adaptation layers. Further, the first and second loop back processors can return signals received from the ATM adaptation layers thereto, not transmit it to the first and second ATM physical layers. That is, the first and second loop back processors read the head value of a signal to return data to an original transmission location from which the data is sent.

As described above, the present invention supports multi-line optical signal matching function to improve space utility, increase economic effect and provide high-rate data (especially, multimedia data) service at 155 Mbps or more. Furthermore, the ATM optical signal matching apparatus of the invention includes the loop back processors connected to maintenance device to accurately find out points having problems rapidly.

What is claimed is:

1. An ATM optical signal matching apparatus, comprising:
a plurality of photoelectric conversion parts for photoelectric-converting input data;
a plurality of user-network matching parts for processing signals transmitted/received through the photoelectric conversion parts;
a bus switch for exchanging signals with the plurality of user-network matching parts;
a loop back processor for returning a signal received through the bus switch to an original transmitter sending the signal according to a predetermine control signal; and
a controller for providing a control signal to the user-network matching parts and the loop back processor according to a program stored therein.

2. The ATM optical signal matching apparatus as claimed in claim 1, wherein each of the plurality of photoelectric conversion parts photoelectric-converts data having the transfer rate of 155.520 Mbps.

3. The ATM optical signal matching apparatus as claimed in claim 1, wherein each of the plurality of user-network matching parts is connected to four of the photoelectric conversion parts to match data at the transfer rate of 622 Mbps.

4. The ATM optical signal matching apparatus as claimed in claim 1, wherein the controller includes a flash memory that is a nonvolatile memory, a synchronous RAM that is a volatile memory, and a microprocessor connected to the flash memory and the synchronous RAM to perform a predetermined operation function.

5. The ATM optical signal matching apparatus as claimed in claim 1, further comprising a first oscillator connected to the user-network matching parts to generate a reference clock for synchronizing data transmitted/received at the transfer rate of 155.520 Mbps, and a second oscillator connected to the user-network matching parts for generating a predetermined clock as the system clock of the user-network matching parts to match transmission/reception data to UTOPIA level 2.

6. The ATM optical signal matching apparatus as claimed in claim 5, wherein the first oscillator generates 19.44 MHz clock and the second oscillator generates 50 MHz clock.
